(19) United States
(12) Patent Application Publication
(10) Pub. No.: US 2013/0211962 A1
(43) Pub. Date: Aug. 15, 2013

(54) VIRTUAL SHOPPING ASSISTANT

(71) Applicant: Donald SPECTOR, New York, NY (US)

(72) Inventor: Donald SPECTOR, New York, NY (US)

(21) Appl. No.: 13/426,899

(22) Filed: Mar. 22, 2012

Related U.S. Application Data
(63) Continuation-in-part of application No. 13/370,761, filed on Feb. 10, 2012.
(60) Provisional application No. 61/601,158, filed on Feb. 21, 2012.
(60) Provisional application No. 61/606,404, filed on Mar. 3, 2012.

(51) Int. Cl. G06Q 30/06

(52) U.S. Cl. 705/26.43

(57) ABSTRACT

A method and system for purchasing an item includes registering identification and credit card information of a shopper with a third party purchasing system, selecting a desired item in a store by a shopper, and sending information identifying the item and its price to the third party purchasing system. The third party purchasing system conducts a search for the item on the internet and analyzes the results of the search via the microprocessor to determine prices of the item. The system then compares the lowest price of the item found in the search with the price of the item sent by the shopper and purchases with the shopper's credit card information the item having the lowest price based on the search, when the lowest price is lower than the price submitted by the shopper.

### CROSS REFERENCE TO RELATED APPLICATIONS

This is a continuation-in-part of U.S. patent application Ser. No. 13/370,761, filed on Feb. 10, 2012. This application also claims priority under 35 U.S.C. 119(e) of U.S. Provisional Application No. 61/606,404, flied on Mar. 3, 2012, and U.S. Provisional Application No. 61/601,158, filed on Feb. 21, 2012.

### BACKGROUND OF THE INVENTION

1. Field of the Invention

This invention relates to a virtual shopping assistant. In particular, the invention relates to a computerized system that enables a shopper to input information about an item that the user sees in a store or on the Internet, wherein the system then searches for the item at a better price on the internet, and if the better price is located, purchases the item for the shopper.

2. The Prior Art

Shopping on the internet has become very popular, due to the wide variety of goods available, and the ability to compare prices. However, shopping in actual retail stores still has an appeal, because the user can actually see the goods before purchasing. The disadvantage in shopping in retail stores, however, is that the user may not obtain the best possible price. In addition, it can require a lot of time to purchase an item if the store is busy. It would be desirable to have a way to enable a shopper to quickly and easily purchase an item seen in a store, while also obtaining the best price.

### SUMMARY OF THE INVENTION

It is therefore an object of the invention to provide a system and method that allows a shopper to quickly and easily purchase a desired item at the best price.

This and other objects are accomplished by a method and system for purchasing items that utilizes a third party purchasing system that purchases the items at the request of a shopper. A shopper first registers their identification and credit card information with the third party purchasing system, which stores this information in a database on a server. This can be accomplished by inputting the shopper's name, address, credit card number, and expiration date into a form on a computer, which is then transmitted to the third party purchasing system for storage in the database. The information could also be conveyed by telephone.

At this point, the third party purchasing system now has the power to make purchases on behalf of the shopper.

In the method according to the invention, the shopper selects a desired item for purchase. This selection could be made in a brick-and-mortar store, or could be over the internet. The shopper then sends information identifying this item to the third party purchasing system. The information can include a picture of the item and/or a description of the item. The shopper also sends a price of the item as found by the shopper. The shopper can send this information to the third part purchasing system by any known means, such as email, text message, voice, fax, etc.

The third party purchasing system then conducts a search for the item on the internet via a microprocessor of the third party purchasing system. The search can be a fully automated search that occurs directly upon receiving the information from the shopper. The third party purchasing system can be equipped with software that analyzes the words and/or pictures sent by the shopper to create the search. Alternatively, the third party purchasing system can utilize human assistance in the search, to make sure that the correct item is being searched.

The search results are analyzed by the microprocessor to determine prices of each item searched. The item with the lowest price, if that price is lower than the price provided by the shopper, is then purchased by the third party purchasing system and sent to the shopper, using the shopper's credit card number and shipping address on file in the database. After the purchase has been made, the third party purchasing system transmits a purchase receipt to the shopper, either by text message or email, or by making it available on a web page accessible to the shopper. The purchasing and receipt transmittal can be entirely automated by the microprocessor.

In one embodiment, the third party purchasing system also utilizes the additional step of verifying the identity of the item prior to searching for the item on the internet. This is to avoid any mistakes in the purchasing of the item. The verification step can include scanning the photograph with identification software, searching for an item matching the appearance of the item in the photograph on the internet, sending a query to the shopper with identification information regarding the item, and receiving verification from the shopper.

Preferably, all of the communications between the shopper and the third party purchasing system take place via a mobile telephone of the shopper. The shopper can use the camera of the mobile telephone to send a picture of the item by text message or email to the third party purchasing system, or can send a text or email with the description of the item, or describe the item in a telephone call. The microprocessor of the third party purchasing system can have voice recognition software that translates the voice instructions of the shopper into computer commands that start the search.

In another embodiment, the shopper can also specify a minimum shipping time for receiving the item. The third party purchasing system then analyzes shipping times for each item found in the search, and only purchases an item having a shipping time within the minimum shipping time specified by the shopper. Thus, if a shopper sees a desired toaster in a store for $49, they can send a picture or description of the toaster to the third party purchasing system, with a requirement that shipping time be no longer than 7 days. The third party purchasing system will then look for the lowest price toaster than will arrive to the shopper within 7 days. If the third party purchasing system can find a toaster for less than $49 (including shipping charges) within the specified shipping time, the third party purchasing system will purchase the toaster for the shopper and notify the shopper by text message, email or telephone call. If the third party purchasing system cannot find a toaster meeting the shopper's requirements, it will then notify the shopper, either by email, text message or telephone call. The shopper can then proceed to purchase the toaster in the store, or continue shopping for a better deal elsewhere.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a diagram of the system according to the invention;

FIG. 2 shows a flow diagram of the method steps according to the invention.

### DETAILED DESCRIPTION OF THE PREFERRED EMBODIMENT

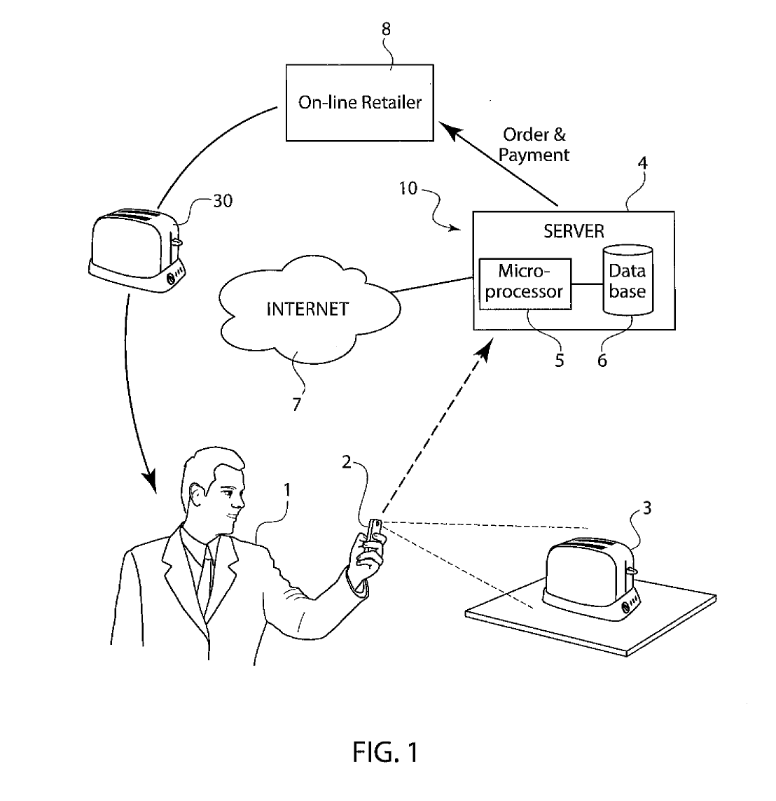

Referring now in detail to the drawings and, in particular, FIG. 1 shows a diagram of the system according to the invention. A shopper 1 sees a product 3 in a store, and desires to purchase product 3. Shopper 1 takes a picture of item 3 with shopper 1's mobile telephone 2 and sends the picture by text or email to a server 4 of a third party purchasing system 10. Shopper 1 also sends a maximum price of item 3 that shopper 1 is willing to pay, to third party purchasing system 10. Shopper 1 could also specify a maximum shipping time, maximum shipping charges, or other parameters to third party purchasing system 10.

Server 4 has a microprocessor 5 and a database 6. Database 6 stores identification and credit card information of all shoppers registered with third party purchasing system 10. The information can include the shopper's name, address, email, mobile telephone number, credit card number, expiration date and any other information needed to process a purchase.

Once server 4 receives the picture of the item 3, software on server 4 scans the picture and searches the internet 7 for an item 30 matching the picture. If such an item 30 is found, microprocessor 5 also assesses whether the price and/or shipping parameters specified by shopper 1 are met. If the item 30 found by third party purchasing system 10 meets the parameters specified by shopper 1, then third party purchasing system 10 purchases the item 30 from on-line retailer 8, who is offering this item. Third party purchasing system 10 uses the shopper 1's credit card and identification information to order the item 30 and have it shipped directly to shopper 1. In the event that third part purchasing system 10 cannot locate an item meeting shopper 1's parameters, it informs shopper 1 via text message, email or voice telephone call. At this point, shopper 1 may decide to purchase item 3 in the store where it was first seen.

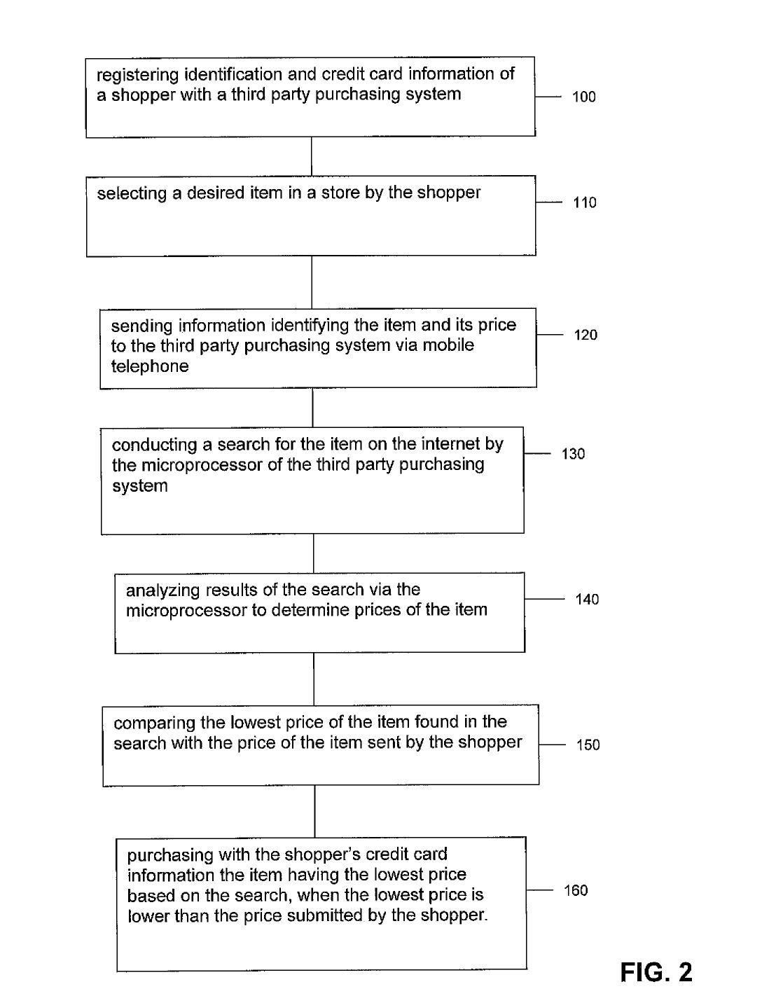

The method for purchasing the item 30 as described above are listed in the flow chart in FIG. 2. In step 100, the shopper registers their identification and credit card information with a third party purchasing system, by sending this information over the Internet or via email, text message or telephone call to the third party purchasing system, which stores this information in a database which is connected to a microprocessor. In step 110, the shopper goes to a store and selects a desired item for purchase. In step 120, the shopper sends information identifying the item to the third party purchasing system. This step of sending could involve taking photograph of the item and sending it via email or text message to the third party purchasing system, or sending a description of the item via email, text message or telephone call fo the third party purchasing system. The shopper also sends the price of the item viewed or a maximum price that the shopper is willing to pay. The shopper can also send other parameters as well, such as color choices, shipping rates, maximum shipping time, or any other parameter that the shopper chooses.

In step 130, the microprocessor processes all of the information sent by the shopper and conducts a search of the internet for the desired item. If the item is found, the microprocessor analyses the item to see if the parameters send by the shopper, i.e., price, shipping time, etc. are met. In steps 140 and 150, the third party purchasing system can analyze all of the items found in the search to determine their prices and shipping details, and compare them to the price of item found by the shopper, or the shopper's maximum price, to determine the item that has the lowest price, shipping fee, shipping rate, etc., to maximize the benefit to the shopper. Once an item meeting all of the shopper's criteria has been met, the third party purchasing system purchases the item with the shoppers credit card in step 160. The retailer then sends the item directly to the shopper using the shopper's identification information provided by the third party purchasing system.

The third party purchasing system can transmit a purchase receipt immediately to the shopper after the item has been purchased. This can be done by text message or email.

In an additional step, the third party purchasing system can verify the identity of the item sent by the shopper by scanning the photograph with identification software, searching for an item matching the appearance of the item in the photograph on the internet, sending a query to the shopper with identification information regarding the item, and receiving verification from the shopper. This can be done automatically via the microprocessor or with the aid of a human.

In another embodiment, the shopper 1 does not need to actually see the item in the store, but can request it directly from the third party shopping system. In this embodiment, the shopper can text, email or call the third party shopping system with a description of the item requested, along with other parameter, such as price, shipping time, etc. This could also be used for travel purchases, such as airline tickets, rental car reservations, hotel rooms, etc. For example, the shopper 1 could request airline tickets from New York to Houston on a specified date for a maximum price. The shopping system would search the internet for the tickets and if there is a flight at or below the maximum price, automatically purchase the tickets for the shopper.

The present invention acts as a personal automated concierge, which takes care of the shoppers's purchasing needs. The present invention saves the shopper time and money by automatically searching out the best price of the desired item and purchasing it for the shopper.

Accordingly, while only a few embodiments of the present invention have been shown and described, it is obvious that many changes and modifications may be made thereunto without departing from the spirit and scope of the invention.

1. A method for purchasing an item, comprising:
registering identification and credit card information of a shopper with a third party purchasing system, said identification and credit card information being stored in a database which is connected to a microprocessor;
identifying a desired item by a shopper;
sending information identifying said item to said third party purchasing system by said shopper;
automatically conducting a search for the item on the internet by said microprocessor of said third party purchasing system; and
automatically purchasing the item for the shopper with the shopper's credit card information by the microprocessor.

2. The method according to claim 1, wherein the shopper provides a maximum price of the item to the third party purchasing system, and further comprising the steps of:
analyzing results of the search via the microprocessor to determine prices of the item; and
comparing via the microprocessor a lowest price of the item found in the search with the maximum price of the item sent by the shopper, and wherein in the step of purchasing the third party shopping network purchases the item having the lowest price based on the search, when the lowest price is equal to or lower than the maximum price submitted by the shopper.

3. The method according to claim 1, further comprising the step of transmitting a purchase receipt to the shopper via the microprocessor after the item has been purchased by the third party purchasing system.

4. The method according to claim 1, wherein the step of sending information identifying said item comprises taking a photograph of the item and sending it to the third party purchasing system via text message or email.

5. The method according to claim 4, further comprising the step of verifying the identity of the item prior to the step of conducting a search, the step of verifying comprising scanning the photograph with identification software, searching for an item matching the appearance of the item in the photograph on the internet with said identification software, sending a query to the shopper with identification information regarding the item, and receiving verification from the shopper.

6. The method according to claim 1, wherein the step of registering identification and credit card information comprises inputting the shopper's name, address, credit card number, and expiration date into a form on a computer, said form being transmitted to the third party purchasing system for storage in the database.

7. The method according to claim 1, wherein the step of sending information takes place via a mobile telephone of the shopper.

8. The method according to claim 2, wherein the step of sending also includes a minimum shipping time for receiving the item, and wherein the step of analyzing includes analyzing shipping times for each item found in the search, and wherein the step of purchasing includes only purchasing an item having a shipping time within the minimum shipping time specified by the shopper.

9. The method according to claim 7, wherein the step of sending occurs via voice instructions of the shopper on the mobile telephone.

10. The method according to claim 9, wherein the microprocessor has voice recognition software that translates the voice instructions into computer commands that start the step of conducting a search.
